(19) United States
(12) Patent Application Publication
(10) Pub. No.: US 2013/0136963 A1
(43) Pub. Date: May 30, 2013

(54) BATTERY MODULE AND BATTERY SYSTEM

(71) Applicant: MITSUBISHI HEAVY INDUSTRIES, LTD., Tokyo (JP)

(72) Inventor: Daisuke Chiba, Tokyo (JP)

(73) Assignee: MITSUBISHI HEAVY INDUSTRIES, LTD., Tokyo (JP)

(21) Appl. No.: 13/686,084

(22) Filed: Nov. 27, 2012

(30) Foreign Application Priority Data
Nov. 30, 2011 (JP) 2011-261131

(51) Int. Cl. H01M 10/42

(52) U.S. Cl. CPC H01M 10/4235
USPC 429/61

(57) ABSTRACT

A battery module includes a first confinement plate, a battery, a second confinement plate that has a deformation portion, and a fixing member that fixes the first confinement plate and the second confinement plate through the use of the deformation portion in a state where the battery is interposed and confined between the first confinement plate and the second confinement plate. The deformation portion is deformed to alleviate the pressure while maintaining the confined state when the pressure in the battery reaches a predetermined value.

### BACKGROUND OF THE INVENTION

1. Field of the Invention

The present invention relates to a battery module and a battery system, and more particularly, to a battery module and a battery system allowing an efficient operation of a battery.

Priority is claimed on Japanese Patent Application No. 2011-261131, filed on Nov. 30, 2011, the content of which is incorporated herein by reference.

2. Description of Related Art

Batteries can be classified into primary batteries which can be only discharged and secondary batteries which can be discharged and charged. These batteries have a structure in which an electrode assembly having electrode plates, that is, a positive electrode plate and a negative electrode plate, stacked with a separator interposed between them is enclosed in a battery case, and are generally used to supply power for driving an electric load such as a motor in a battery system.

However, in these batteries, when they degrade or charging and discharging are repeated, it is known that gas is generated in the battery case and the battery case is deformed. When the battery case is deformed, the gap between the positive electrode plate and the negative electrode plate constituting the electrode assembly received in the battery case increases and the battery performance may be consequently lowered.

Therefore, a battery module has been proposed in which a battery is interposed between pressing plates to prevent the deformation (see Japanese Unexamined Patent Application, First Publication No. 2005-339932, Japanese Unexamined Patent Application, First Publication No. 2008-235149, and Japanese Unexamined Patent Application, First Publication No. 2010-40345).

On the other hand, as in the battery module described in the above mentioned Japanese Patent documents, when batteries are interposed and fixed between the pressing plates, the deformation of the battery case can be prevented, but the pressure (hereinafter, referred to as an internal pressure) in the battery case can easily rise. Therefore, in order to prevent the battery case from exploding to secure safety of the battery module, a configuration as described Japanese Unexamined Patent Application, First Publication No. 2005-339932 has been employed in which a safety valve which is broken at a pressure value (hereinafter, referred to as a precaution value) set to prevent the explosion of the battery case is disposed or in which the output of the battery module is stopped when the internal pressure of the battery case reaches the precaution value.

In this manner, in the configuration in which a safety valve that explodes to alleviate the internal pressure when the internal pressure of the battery case reaches the precaution value is disposed or in the configuration in which the output of the battery module is stopped when the internal pressure of the battery case reaches the precaution value, the battery of the battery module still cannot be used when the internal pressure once reaches the precaution value. In other words, in order to secure the safety of the battery module, it is necessary to stop using the battery module when the internal pressure reaches the precaution value.

However, when the internal pressure of the battery interposed between two pressing plates first reaches the precaution value, it is proved that although the battery case itself may explode in this state, the electrode assembly or the like can be used for a while.

Therefore, an object of the invention is to provide a battery module and a battery system allowing an efficient operation of a battery with a simple configuration.

### SUMMARY OF THE INVENTION

According to an aspect of the invention, there is provided a battery module including: a first confinement plate; a battery; a second confinement plate that has a deformation portion; and a fixing member that fixes the first confinement plate and the second confinement plate through the use of the deformation portion in a state where the battery is interposed and confined between the first confinement plate and the second confinement plate, wherein the deformation portion is deformed to alleviate the pressure while maintaining the confined state when the pressure in the battery reaches a predetermined value.

In the battery module according to the aspect of the invention, when the internal pressure of a battery first reaches a predetermined value, the deformation portion is deformed and the internal pressure is alleviated in a state where the battery is confined by two confinement plates corresponding to the pressing plates. Accordingly, since the time for the internal pressure to reach the precaution value can be delayed for a while, it is possible to efficiently operate the battery.

According to another aspect of the invention, there is provided a battery system including: a battery module that includes a first confinement plate, a battery, a second confinement plate having a deformation portion, and a fixing member fixing the first confinement plate and the second confinement plate through the use of the deformation portion in a state where the battery is interposed and confined between the first confinement plate and the second confinement plate; an electric load that is driven by a supply of power from the battery; a switch that intercepts the supply of power; and a control device that controls the interception of the switch, wherein the deformation portion is deformed to alleviate the pressure while maintaining the confined state when the pressure in the battery of the battery module reaches a predetermined value, and then the control device performs the interception when the pressure in the battery rises again and reaches the vicinity of a precaution value.

In the battery system according to the aspect of the invention, when the internal pressure of a battery first reaches a predetermined value, the deformation portion is deformed and the internal pressure is alleviated in a state where the battery is confined by two confinement plates corresponding to the pressing plates. Accordingly, since the time for the internal pressure to reach the precaution value can be delayed for a while, it is possible to efficiently operate the battery.

Thereafter, when the internal pressure of the battery rises again and reaches the vicinity of the precaution value, the control device intercepts the supply of current from the battery. Accordingly, for example, just before the safety valve explodes, it is possible to stop the rising of an internal pressure and thus to further improve the safety of the battery system.

According to the aspects of the invention, it is possible to provide a battery module and a battery system allowing an efficient operation of a battery with a simple configuration.

### BRIEF DESCRIPTION OF THE DRAWINGS

FIG. 1 is a schematic diagram illustrating a battery module and a battery system according to an embodiment of the invention.

FIG. 2A is a schematic diagram of a confinement plate 10A used in the battery module shown in FIG. 1 on the XZ plane.

FIG. 2B is a schematic cross-sectional view of a deformation portion 16, which has not been deformed, taken along line A-A′ in the XY cross-section.

FIG. 2C is a schematic cross-sectional view of the deformation portion 16, which has been deformed, taken along line A-A′ in the XY cross-section.

FIG. 3A is a schematic diagram of a confinement plate 10B used in the battery module shown in FIG. 1 on the XZ plane.

FIG. 3B is a schematic cross-sectional view of a deformation portion 16 taken along line B-B′ in the XY cross-section.

FIG. 3C is a schematic cross-sectional view of the deformation portion 16 taken along line C-C′ in the XY cross-section.

FIG. 4 is a modified example of the battery module shown in FIG. 1.

### DETAILED DESCRIPTION OF THE INVENTION

In a battery module and a battery system according to an embodiment of the invention, a state where battery cases are interposed and confined between two confinement plates is maintained and a deformation portion formed in a confinement plate is deformed to alleviate an internal pressure when the internal pressure of a battery rises and reaches a predetermined value. Hereinafter, the battery module and the battery system according to the embodiment will be described in detail with reference to the accompanying drawings.

Either a primary battery or a secondary battery can be used as the battery according to this embodiment, but it is assumed that a rechargeable battery such as a lithium ion secondary battery is used as a storage battery, as an example of the battery.

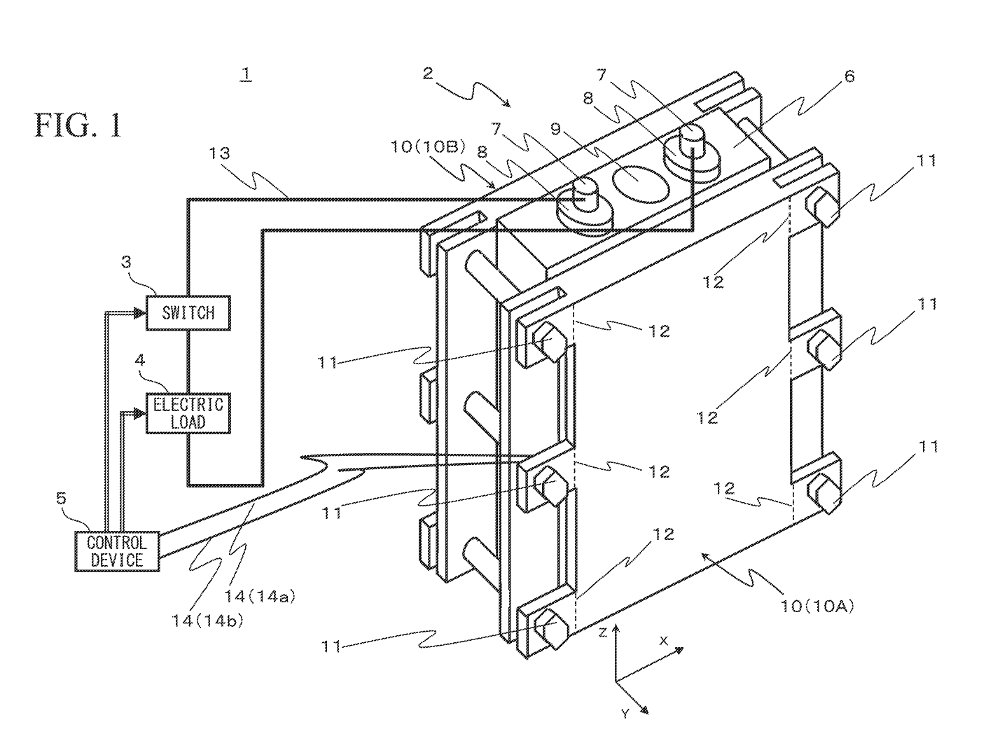

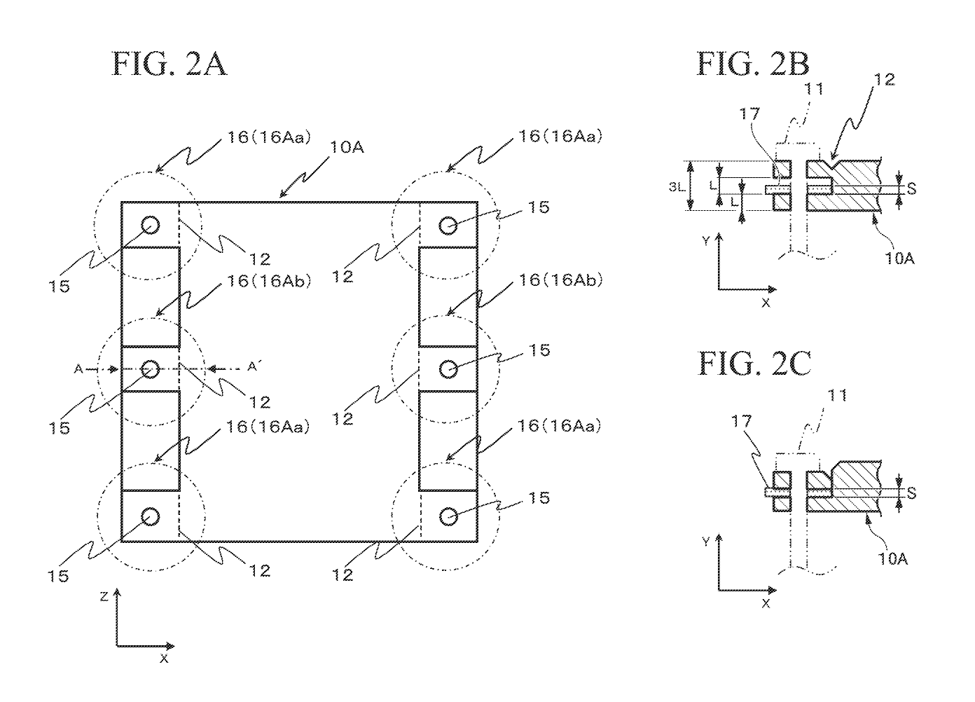

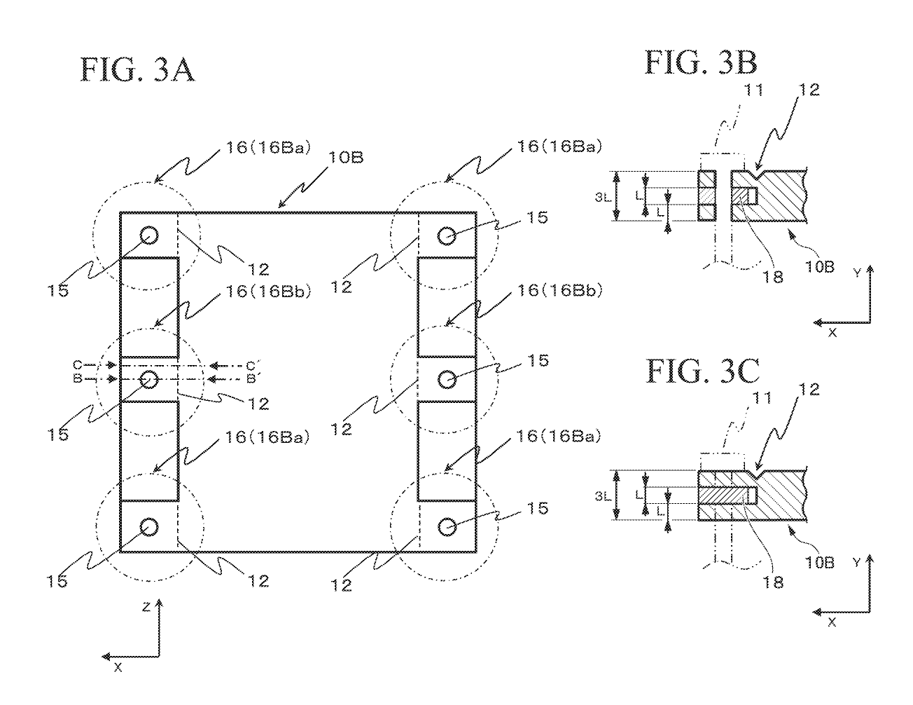

A battery system 1 and a battery module 2 according to this embodiment will be described with reference to FIGS. 1 to 3C. FIG. 1 is a schematic diagram of a battery system 1 including a battery module 2. FIGS. 2A to 2C and FIGS. 3A to 3C are schematic diagrams of a confinement plate 10 used in the battery module 2 shown in FIG. 1. The drawings mentioned below use the same orthogonal coordinate system.

First, a battery 6 includes a square-like conductive (formed of metal such as aluminum) case body having a substantially rectangular bottom surface on the XY plane and a wall surface extending in the Z axis direction from all sides of the substantially rectangular shape, an electrode assembly that is received in the case body 2 and in which a positive electrode plate and a negative electrode plate are stacked with a separator interposed therebetween, and a cover that air-tightly encloses the case body after receiving the electrode assembly in the case body.

Here, the case body and the cover are air-tightly sealed through laser welding or the like to form a “battery case”. An electrolytic solution or an electrolyte is stored in the battery case.

The cover is formed of the same conductive material as the case body. In the cover, a pair of electrode terminals 7 (that is, a positive electrode terminal and a negative electrode terminal) having, for example, a cylindrical shape and penetrating the cover and an insulating resin 8 (an insulator such as a plastic resin) electrically insulating the electrode terminals and the cover from each other.

A positive electrode plate is electrically connected to the positive electrode terminal and a negative electrode plate is electrically connected to the negative electrode terminal.

A safety valve 9 that explodes to connect the inside and the outside of the battery case when the internal pressure of the battery 6 reaches a precaution value is disposed in the battery 6.

The battery module 2 is formed by inserting the battery case between the pair of confinement plates 10 from the Y direction, contacting and substantially covering two XZ planes of the battery case with the pair of confinement plates, and fixing the pair of confinement plates 10 to each other with a fixing member 11. The confinement plates 10 (that is, 10A and 10B) have the same shape and size and are formed of the same material (such as an insulating resin).

The shape of the confinement plate 10 will be described in detail below. Since the confinement plates 10A and 10B have the same shape, the confinement plate 10A will be representatively described.

The confinement plate 10A has a substantially rectangular shape when seen in the XZ plane, as shown in FIG. 2A. The confinement plate 10A has a shape in which the vicinity of the center in the Y direction (that is, the thickness direction of the confinement plate 10) of an end face (that is, the XY plane) existing in the −X direction and extending in the Z direction is indented by a predetermined distance to the +X side and the vicinity of the center in the Y direction (that is, the thickness direction of the confinement plate 10) of an end face (that is, the XY plane) existing in the +X direction and extending in the Z direction is indented by a predetermined distance to the −X side. In a part (hereinafter, referred to as a “squared U-shaped part”) having a squared U-shape in the XY plane due to the indented part, two planes of the XZ plane on the +Y side and the XZ plane on the +Y side are present, but the +Y-side plane has a shape in which both ends and the central part of the indented shape are left and a part of the plane is removed.

The squared U-shaped parts of both ends and the center become deformation portions 16. That is, as shown in FIG. 2A, when seen in the XZ plane, three deformation portions 16 are formed on the confinement plate 10 so as to be along an edge of the −X side of the confinement plate 10 extending in the Z direction. In addition, three deformation portions 16 are formed on the confinement plate 10 so as to be along an edge of the +X side of the confinement plate 10 extending in the Z direction. The three deformation portions 16 formed along the −X side edge are arranged at equal intervals in the Z direction and the three deformation portions 16 formed along the +X side edge are arranged at equal intervals in the Z direction.

A through-hole 15 penetrating two the squared U-shaped planes in the Y direction is formed in each of the deformation portions 16. The diameter of the through-hole 15 is substantially equal to or slightly larger than the diameter of the shaft of a bolt as a fixing member 11 to be described later and is smaller than the diameter of the head of the bolt.

A notch 12 is formed in one of two corners included in the squared U-shape of the squared U-shaped part. The notch 12 has a wedge shape indented in the −Y direction from the surface of the confinement plate 10A, wherein the wedge shape is continuously drawn in a linear shape in the Z direction.

The battery module 2 is formed by interposing the battery case of the battery 6 between the pair of confinement plate 10A and confinement plate 10B so that the notches 12 face the outside, then passing bolts as fixing members through the corresponding through-holes 15 from the confinement plate 10A to the confinement plate 10B, and then fastening nuts as fixing members to the shafts of the bolts protruding from the through-holes 15 of the confinement plate 10B to fix the pair of confinement plates 10 to the battery 6. The fastening is performed so that the battery 6 is confined so as not to freely move by the pair of confinement plates 10. In FIG. 1, the fixation using the fixing members is performed at six positions.

The deforming operation of the deformation portions 16 will be described below in detail. Since six deformation portions 16 of the confinement plate 10A perform the same deformation operation, the deformation operation of a deformation portion 16Ab existing at the center will be representatively described instead of a deformation portion 16Aa existing at the corner of the confinement plate 10A.

FIG. 2B is an XY cross-sectional view of the deformation portion 16Aa taken along line A-A′ of FIG. 2A. For ease of explanation, a part of the shaft and the head of a bolt as the fixing member 11 are indicated by a two-dotted chained line.

As shown in FIG. 2B, the deformation portion 16 has the squared U-shape. Here, when the thickness of the confinement plate 10A is “3×L” (for example, L=5 mm), the thickness of each of the two planes forming the squared U-shaped part is designed to L. Accordingly, the space existing between the two planes has a size of L. In the space, a pressure sensor 17 (such as a piezoelectric sensor) of which the thickness in the Y direction is a size S (for example, S=2 mm) smaller than the size L is disposed to penetrate the shaft of the bolt. Two lines 14 for a pressure sensor (that is, pressure-sensor lines 14a and 14b) shown in FIG. 1 are connected to the pressure sensor 17.

When gas is generated in the battery case and the internal pressure of the battery case reaches a predetermined value which is substantially equal to or slightly less than a precaution value, the gap between the head of the bolt and the nut as the fixing member is constant and thus a part of the deformation portion 16 is broken in the Y direction from the notch 12. That is, one plane in which the notch 12 is formed out of two planes of the squared U-shaped part of the deformation portion 16 is separated from the confinement plate 10A. Accordingly, as shown in FIG. 2C, the confinement plate 10A itself can move to the head of the bolt as the fixing member (that is, in the +Y direction) by a size “L−S”. At this time, since the head is configured to stop at last at the other plane (that is, the plane other than the separated plane) of the two planes of the squared U-shaped part of the deformation portion 16, the confinement of the battery 6 using the pair of confinement plates 10 is still maintained.

At this time, as shown in FIGS. 3B and 3C, a deformation preventing member 18 (for example, a reinforced plastic) of which the thickness in the Y direction is L is disposed in the space of the squared U-shaped part in the deformation portion 16 of the other confinement plate 10B so as to penetrate the shaft of the bolt. Therefore, even when the internal pressure of the battery case reaches the predetermined value, the part of the deformation portion 16 in which the notch 12 is formed is not broken in the Y direction from the notch 12.

A simple plate-like confinement plate in which the deformation portion 16 is not formed in the confinement plate 10B may be used instead of the confinement plate 10B depending on designs.

Therefore, since the gap between the confinement plate 10A and the confinement plate 10B increases by the size “L−S” due to the deformation of the deformation portion 16 of the confinement plate 10A after the internal pressure of the battery case reaches the predetermined value, it is possible to allow the deformation of the battery case as much. As a result, the internal pressure of the battery case can be lowered and alleviated from the predetermined value. In other words, in the battery module 2 having this configuration, the internal pressure of the battery case reaches the predetermined value and then the internal pressure can be alleviated in a state where the confinement of the battery 6 using the pair of confinement plates 10 is not completely released and is maintained. Accordingly, it is possible to continuously use the battery without significantly increasing the gap between the positive electrode plate and the negative electrode plate in the battery case. Therefore, according to the battery module 2, it is possible to use the battery for a longer period of time without deteriorating the battery performance. That is, it is possible to efficiently operate the battery 6.

In the battery module 2, part of the deformation portion 16 is separated, but part of the deformation portion may be configured to be bent as long as it can be substantially separated without actually being separated.

The deformation portions 16 formed in the confinement plate 10 are preferably arranged to be symmetric about the central line of the confinement plate 10, as shown in FIGS. 2A to 2C or FIGS. 3A to 3C, so as to make the pressure applied from the confinement plate 10 to the battery 6 uniform. In order to strengthen the confinement, the deformation portion 16Aa or 16Ba is preferably formed at least in the vicinities of four corners of the confinement plate 10.

Although it is stated that the deformation portions 16 are part of the confinement plate 10, deformation portions 16 may be prepared as separate members from the confinement plate 10 and the deformation portions 16 may be connected to the confinement plate 10, as long as they can be formed in the same way as described above.

The battery system 1 using the battery module 2 will be described below with reference to FIG. 1. Two electrode terminals 7 (that is, the positive electrode terminal and the negative electrode terminal) of the battery 6 disposed in the battery module 2 are connected to a switch 3 and an electric power load 4 (for example, an electric motor) connected in series via a power supply line 13. That is, when the switch 3 is in a connected state (that is, ON state), power can be supplied to the electric power load 4 from the battery 6.

A control device 5 controls an amount of load of the electric power load 4 and alternatively controls the switch 3 to be in the connected state (that is, the ON state) or the disconnected state (that is, the OFF state). When the battery system 1 is an electric vehicle running in a private area such as a plant and the electric power load is an electric motor driving the wheels of the electric vehicle, the control device 5 changes the switch 3 from the disconnected state to the connected state by a user's startup operation (that is, an ignition-on operation) and the control device 5 controls an amount of power supply to the electric power load 4 depending on the user's stepping on an accelerator. The control device 5 changes the switch 3 from the connected state to the disconnected state by the user's ending operation (that is, an ignition-off operation).

The pressure-sensor lines 14 are connected to the control device 5. That is, the control device 5 receives a signal on the pressure sensed by the pressure sensor 17 via the lines. When the signal from the pressure sensor corresponds to the precaution value, the control device 5 changes the switch 3 from the connected state to the disconnected state to forcibly intercept the supply of power to the electric power load 4.

Accordingly, when it is detected by the pressure sensor 17 that the internal pressure starts rising again and the internal pressure reaches the precaution value after the internal pressure of the battery is alleviated form the predetermined value by deforming the deformation portions 16 of the battery module 2, it is possible to forcibly stop the battery system 1.

Therefore, when the battery having the safety valve 9 disposed therein is used for a battery system, it is possible to safely exchange the corresponding battery 6 before the safety valve 9 explodes. Accordingly, since other constituent components of the battery system 1 are not contaminated or corroded by gas generated in the battery 6, it is possible to reduce a user's burden in terms of replacement and repair costs.

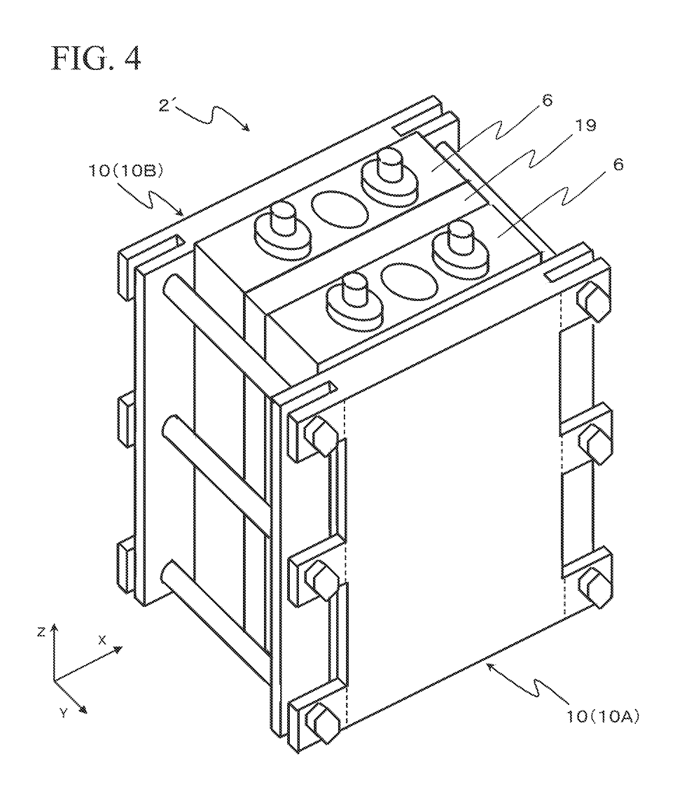

A modified Example 2′ of the battery module 2 is shown in FIG. 4. The modified example 2′ is different from the battery module 2 in that two batteries 6 are disposed with a heat sink 19, which cools the battery 6, interposed therebetween, and is equal to the battery module 2 otherwise. Therefore, the same elements will be referenced by the same reference numerals as in the battery module 2 and description thereof will not be repeated.

Two batteries 5 constitute a battery assembly and are connected in series or in parallel in the modified example 2′ via a line not shown.

The advantages of the battery module 2′ having this configuration and the advantages of a case where the battery module 2′ is applied to the battery system shown in FIG. 1 are the same as the advantages of the battery module 2 and the battery system 1 shown in FIG. 1.

The number of batteries 6 built in the battery module may be one or more and can be appropriately changed depending on the design specification.

The invention is not limited to the above-mentioned embodiment, modified examples thereof, or combinations thereof, but may be modified in various forms without departing from the concept of the invention. For example, it is stated that the battery case has a square shape, but the battery case may have a cylindrical shape. Similarly, the electrode assembly may be an electrode assembly (stacked electrode assembly) in which multiple positive electrode plates and multiple negative electrode plates are sequentially stacked with a separator interposed therebetween, or may be an electrode assembly (wound electrode assembly) in which one positive electrode plate and one negative electrode plate are stacked with a separator interposed therebetween and which is wound.

Examples of the battery system 1 include industrial vehicles such as forklifts in which vehicle wheels are connected to an electric motor as the electric power load 4, moving objects such as electric trains or electric vehicles, and moving objects such as airplanes or ships in which a propeller or a screw is connected to an electric motor as the electric power load 4. Examples of the battery system 1 further include stationary systems such as a household power storage system and a system-interactive smoothed power storage system combined with natural energy generation such as windmills or solar light. That is, the battery system 1 is a system using at least the discharging of power in the battery 6 of the battery module 2 or may be a system using the charging and discharging of power.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A battery module comprising:
a first confinement plate;
a battery;
a second confinement plate that has a deformation portion; and
a fixing member that fixes the first confinement plate and the second confinement plate through the use of the deformation portion in a state where the battery is interposed and confined between the first confinement plate and the second confinement plate,
wherein the deformation portion is deformed to alleviate the pressure while maintaining the confined state when the pressure in the battery reaches a predetermined value.

2. The battery module according to claim 1, wherein a part of the deformation portion is separated from the second confinement plate when deformation occurs.

3. The battery module according to claim 2, wherein a plurality of the deformation portions are formed to be symmetric about the central line of the second confinement plate and the fixing members of the same number as the number of deformation portions are disposed in the deformation portions to carry out the fixing.

4. The battery module according to claim 3, wherein the battery has a square shape, and
wherein the second confinement plate has a substantially rectangular shape and the deformation portion is formed at each of at least four corners of the substantially rectangular shape.

5. The battery module according to claim 4, wherein each deformation portion is a squared U-shaped portion incorporated into the second confinement plate, a notch is formed in the squared U-shaped portion, and a part of the deformation part of the deformation portion is separated by the notch at the time of deformation.

6. The battery module according to claim 5, wherein each fixing member includes a bolt and a nut fastened to the bolt.

7. A battery system comprising:
a battery module that includes a first confinement plate, a battery, a second confinement plate having a deformation portion, and a fixing member fixing the first confinement plate and the second confinement plate through the use of the deformation portion in a state where the battery is interposed and confined between the first confinement plate and the second confinement plate;
an electric load that is driven by a supply of power from the battery;
a switch that intercepts the supply of power; and
a control device that controls the interception of the switch,
wherein the deformation portion is deformed to alleviate the pressure while maintaining the confined state when the pressure in the battery of the battery module reaches a predetermined value, and then the control device performs the interception when the pressure in the battery rises again and reaches the vicinity of a precaution value.
